(19) United States
(12) Patent Application Publication
(10) Pub. No.: US 2014/0118703 A1
(43) Pub. Date: May 1, 2014

(54) LASER PROJECTION SYSTEM

(71) Applicant: LITE-ON IT CORPORATION, Taipei (TW)

(72) Inventors: Wei-Tien CHANG, Hsinchu (TW); Chih-Chien LU, Hsinchu (TW)

(21) Appl. No.: 13/923,528

(22) Filed: Jun. 21, 2013

(30) Foreign Application Priority Data
Oct. 31, 2012 (CN) 201210427804.0

(51) Int. Cl. G03B 21/14

(52) U.S. Cl. CPC G03B 21/147
USPC 353/69

(57) ABSTRACT

A laser projection system is provided. The laser projection system comprises a laser light source, an optical element and a lens module. The laser light source provides a laser beam. The optical element has a first surface and a second surface. The laser beam is totally reflected by the first surface to pass through the second surface. The lens module is disposed beside the second surface of the optical element for reflecting the laser beam passing through the second surface, such that the reflected laser beam is projected on a projection screen.

This application claims the benefit of People's Republic of China application Serial No. 201210427804.0, filed Oct. 31, 2012, the subject matter of which is incorporated herein by reference.

### BACKGROUND OF THE INVENTION

1. Field of the Invention

The invention relates in general to a laser projection system, and more particularly to a laser projection system capable of improving projection deformation.

2. Description of the Related Art

In a conventional scan type projection system, the beam emitted by the light source is reflected to a micro electro-mechanical system (MEMS) component by two reflecting mirrors. The MEMS component scans the frame by using a spherical coordinate system. When the scanned frame is converted into a frame of the Cartesian coordinate system, the image frame projected on the screen may be easily distorted due to the difference in projection distance and projection angle. That is, the projection frame is distorted, not only deviating from the original image but also causing discomfort to human eyes which are sensitive to the distortion of image.

### SUMMARY OF THE INVENTION

The invention is directed to a laser projection system having a specific optical element capable of adjusting the optical path and improving the distortion and deformation of projection image.

According to an embodiment of the present invention, a laser projection system is provided. The laser projection system comprises a laser light source, an optical element and a lens module. The laser light source provides a laser beam. The optical element has a first surface and a second surface. The laser beam is totally reflected by the first surface to pass through the second surface. The lens module is disposed adjacent to the second surface of the optical element for reflecting the laser beam passing through the second surface, such that the reflected laser beam is projected on a projection screen.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a laser projection system according to an embodiment of the invention;

FIG. 2 shows a schematic diagram of a laser projection system according to another embodiment of the invention;

FIG. 3 shows an imaging method of a laser scan system according to an embodiment of the invention;

FIGS. 4A˜4C show schematic diagrams of a lens geometric distortion computing algorithm;

FIG. 5 shows a schematic diagram of a laser projection system according to an embodiment of the invention;

FIG. 6 shows a simulation diagram of the beam of the laser projection system in FIG. 5 being projected on a projection screen; and

FIG. 7 shows a schematic diagram of an optical element according to an embodiment of the invention.

### DETAILED DESCRIPTION OF THE INVENTION

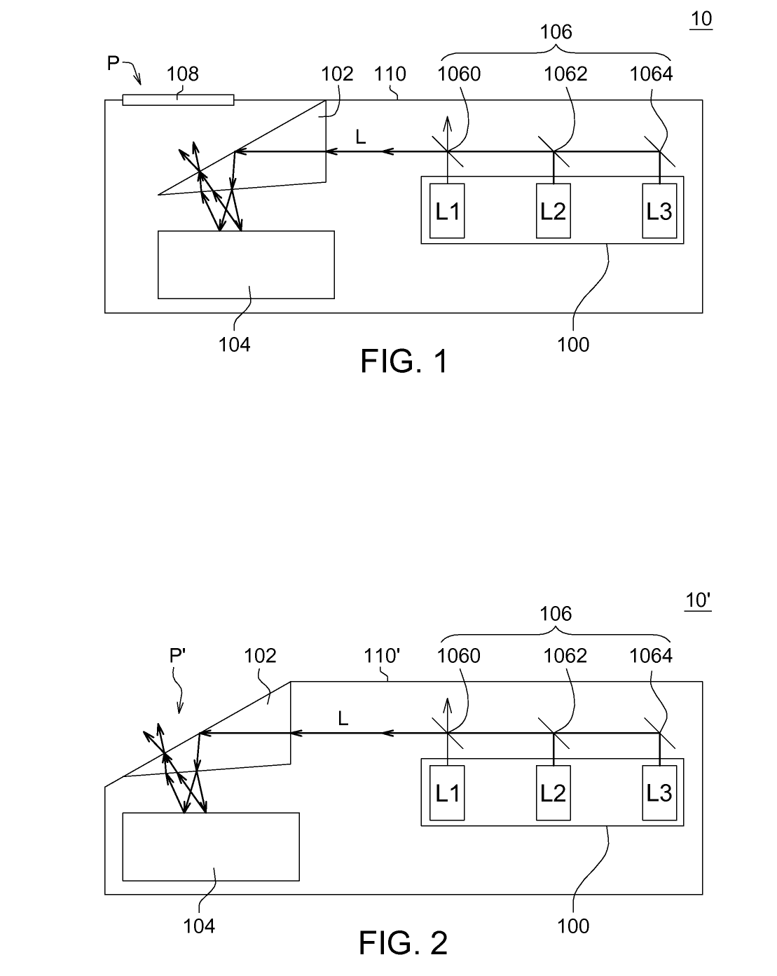

FIG. 1 shows a schematic diagram of a laser projection system 10 according to an embodiment of the invention. The laser projection system 10 comprises a laser light source 100, an optical element 102, a lens module 104, a reflecting mirror assembly 106, a dust cover 108 and a casing 110. The laser light source 100 provides a laser beam L. In an embodiment, the laser light source 100 at least comprises a first beam and a second beam, or additionally comprises an infra-red laser. The first beam and the second beam have different wavelengths and are used as a display light source. The infra-red laser is used as a detection light source which detects whether any object enters the projection range and the distance from the light source to the projection screen.

As indicated FIG. 1, the laser beam L of the laser light source 100 comprises three single-color beams: a red (R) light L1, a green (G) light L2 and a blue (B) light L3, but the invention is not limited thereto. In the present embodiment, the laser beam L of the laser light source 100 is focus-free. The optical element 102 does not jeopardize the focus-free characteristic of the laser beam L of the laser light source 100, hence assuring the focus-free characteristic of the laser light source 100.

The optical element 102 has a cross-section in the shape of a triangle, a quadrangle, or a polygon (such as a prism or a pyramid). In the present embodiment, the shape of the cross-section of the optical element 102 is exemplified by a triangle, but the invention is not limited thereto. The optical element 102 is disposed between the lens module 104 and the laser light source 100 for guiding the light to the lens module 104. The conventional scan type projection system requires two reflecting mirrors for guiding the laser beam to the lens module. The optical element 102 of the invention is used to replace the two reflecting mirrors, not only saving element cost and reducing the assembly time for increasing production capacity, but also saving the required space for benefiting the miniaturization of the laser projection system 10.

The reflecting mirror assembly 106 is selectively disposed for adjusting the optical path of the laser beam L. The reflecting mirror assembly 106 comprises a reflecting mirror 1060, a reflecting mirror 1062 and a reflecting mirror 1064 for reflecting the beams of the red light L1, the green light L2 and the blue light L3 respectively. Preferably, the reflecting mirror assembly 106 has the light filtering function for controlling the light band of the reflected red light L1, green light L2 and blue light L3 to be within the light band of single-color light when the reflected light enters the optical element 102, and reducing the incidence of the non-RGB light which may affect the mixing of the light.

The casing 110 accommodates the laser light source 100, the optical element 102, the lens module 104 and the reflecting mirror assembly 106. The casing 110 has an opening P. The reflected laser beam L passes through the opening P to be projected on the projection screen. To avoid the suspended particulates, such as dust or particles in the air, entering the casing 110 via the opening P and damaging the laser projection system 10, a transparent dust cover 108 can be selectively disposed to seal the opening P of the laser projection system 10 and block the dust.

In the present embodiment, after the laser beam L of the laser light source 100 is reflected by the reflecting mirror assembly 106, the reflected laser beam L enters the optical element 102, and is further reflected and refracted to the lens module 104 by different surfaces of the optical element 102. The lens module 104 comprises a single lens or a lens assembly, and further comprises an active element (not illustrated) for controlling the single lens or the lens assembly to swing in two dimensional directions. After the laser beam L is reflected by the lens module 104, the reflected laser beam L is projected on the projection screen. Since the lens module 104 can swing in two dimensional directions, when the laser beam L reflected by the lens module 104 is projected on the projection screen, the laser beam L forms an image by way of scanning.

In an embodiment, the laser projection system 10 further comprises a carrying mechanism (not illustrated), such that the laser beam L emitted by the opening P is inclined upwards at an angle. Thus, when the laser projection system 10 is placed on a desktop, the problem of projection failure caused by a part of image being projected on the desktop can be effectively avoided.

In another embodiment, any surface of the optical element 102 is tilted relative to a surface of the casing 110. The surface of the casing 110 discussed herein is parallel to the paper direction and is not illustrated in the diagram. By adjusting any surface of the optical element 102 to be tilted relative to a surface of the casing 110, the optical path of the beam in the optical element 102 can be changed, such that the laser beam L emitted by the opening P is inclined upward. Although no carrying mechanism is disposed, a preferred projection angle still can be formed. In the present embodiment, the tilted surface as well as the angle and the direction, in which the optical element 102 is tilted relative to the surface of the casing 110 are all related to the disposition of internal elements of the laser projection system 10, and are not subjected to any specific restrictions.

FIG. 2 shows a schematic diagram of a laser projection system 10′ according to another embodiment of the invention. The laser projection system 10′ of FIG. 2 is similar to the laser projection system 10 of FIG. 1. Common reference numerals are used throughout the drawings and the detailed description to indicate the same elements. The laser projection system 10′ is different from the laser projection system 10 in that the optical element 102 is directly disposed on the position of the opening P′ of the casing 110′ and is used as a dust cover to block the dust.

When the beam passes through the interface of a conventional dust cover, the beam generates a penetrating light and a reflective light at the same time. The reflective light will be reflected in the conventional dust cover back and forth until the light energy is depleted. Therefore, during the process of the beam penetrating the interface of the conventional dust cover and being reflected therein, the penetrating light passing through the interface will bias the brightness or saturation of the projection frame and deteriorate the quality of the projection frame. Therefore, in the present embodiment, the optical element 102 is used to replace the original dust cover. The replacement not only reduces the number and cost of elements but also avoid the stray light affecting the quality of projection image. Since the surfaces of the optical element 102 are not parallel to each other, when the optical element 102 is used to replace the conventional dust cover, the stray light will not be reflected back and forth in the optical element 102. Since the optical path of the stray light will be outside the projection frames, the stray light will not affect the quality of projection frame.

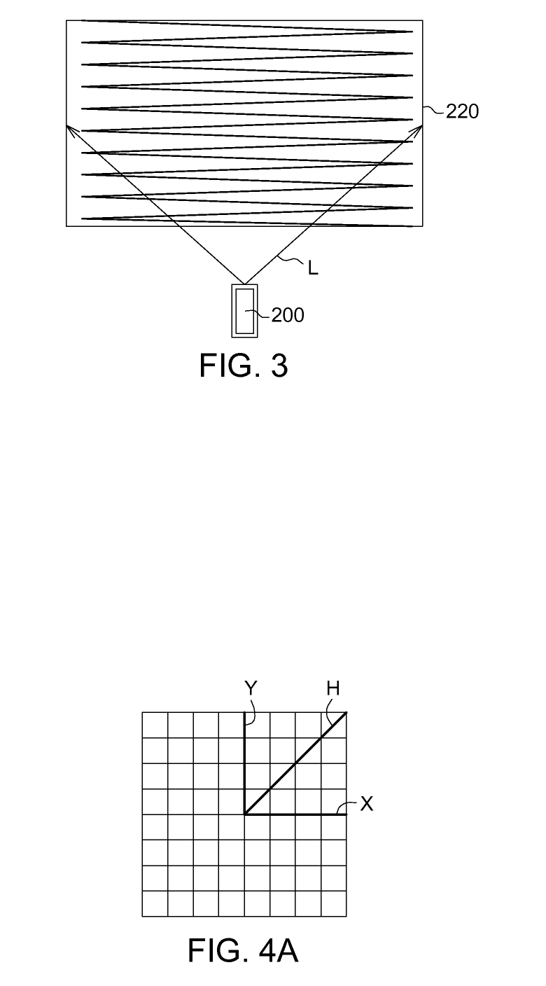

FIG. 3 shows an imaging method of a laser scan system according to an embodiment of the invention. As indicated FIG. 1, after the laser beam L of the laser light source 200 is reflected by the lens module 104 which swings in two dimensional directions, the laser beam L generates Raster scan or Lissajous scan and is projected on the projection screen 220. Based on the theory of vision persistence, as long as the repetition time of the display image of the laser beam L is smaller than the persistence time of eye, the image frame projected on the projection screen 220 can be combined to form a frame in the viewer's brain. Besides, after the laser beam L is reflected by the lens module 104 which swings in two dimensional directions, whether the image produced by the reflected laser beam L projected on the projection screen 220 is deformed or not is related to the transmission path of the laser beam L. A method for determining whether the projection image is deformed and distorted is disclosed below.

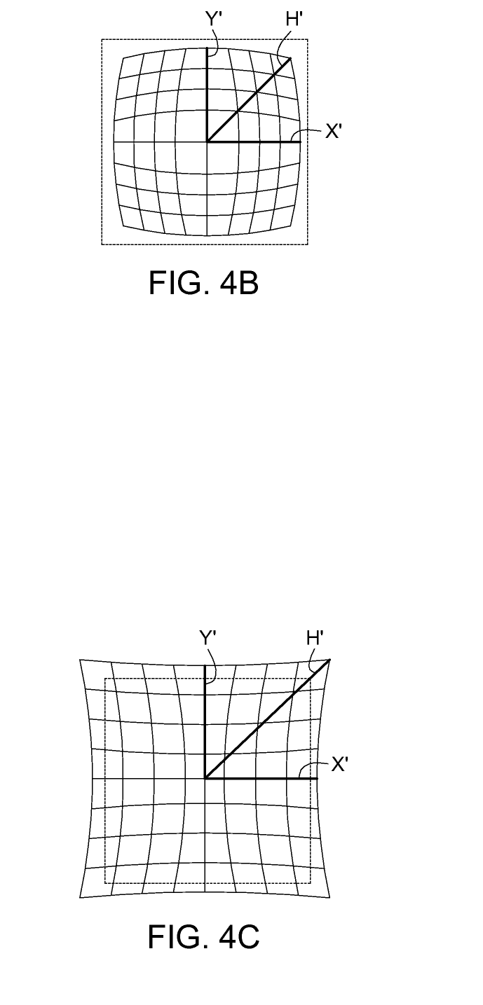

FIGS. 4A˜4C are schematic diagrams of a lens geometric distortion (LGD) algorithm. FIG. 4A shows a schematic diagram of no geometric distortion. FIG. 4B shows a schematic diagram of barrier distortion. FIG. 4C shows a schematic diagram of pincushion distortion. Let FIG. 4A be taken for example. The horizontal axis is designated by X, the vertical axis is designated by Y, the axial line of the bisector between the X axis and the Y axis is designated by H, and the intersection points of each grid are description points of simulated pixel coordinates.

Referring to FIGS. 4A˜4C. Let the calculation of the distortion amount on the H-axis be taken for example. The distortion amount in the H-axis direction can be obtained by bringing the value on the deformed H′-axis (illustrated in FIGS. 4B˜4C) and the value on the non-deformed H-axis (illustrated in FIG. 4A) to the equation:

$$L G D = 100 \times \frac{( {H}^{′} - H )}{H} .$$

Similarly, the distortion amount in the X-axis direction or the Y-axis direction can be obtained by bringing the value on the deformed X′-axis and the value on non-deformed X-axis to the equation:

$$L G D = 100 \times \frac{( {X}^{′} - X )}{X}$$

or bringing the value on the deformed Y′-axis and the value on the non-deformed Y-axis to the equation:

$$L G D = 100 \times \frac{( {Y}^{′} - Y )}{Y} .$$

The distortion of the projection frame can be obtained by bringing the coordinate points of the projection frame in each axial direction to the LGD equation.

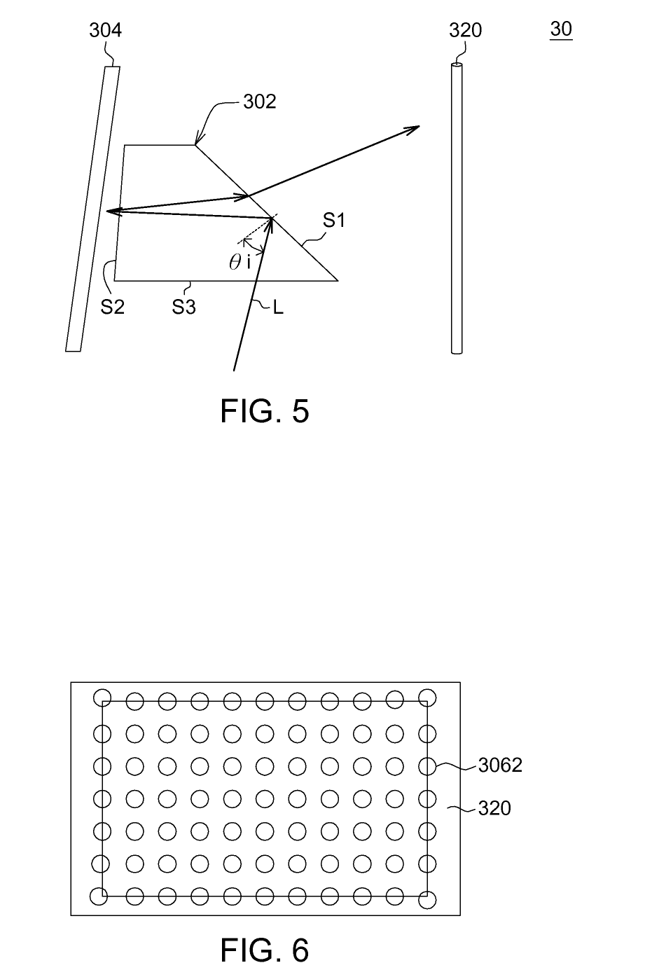

FIG. 5 shows a schematic diagram of a laser projection system 30 according to an embodiment of the invention. Only the laser beam L, the optical element 302, the lens module 304 and the projection screen 320 are illustrated in the laser projection system of FIG. 5, and other elements are omitted to simplify the descriptions. As indicated FIG. 5, the optical element 302 has a first surface S1, a second surface S2 and a third surface S3, and one cross-section of the optical element 302 is a rectangle or similar as that of the optical element 102 of FIG. 1 or other shapes, and the invention is not limited thereto. The lens module 304 (such as a single lens) is disposed besides the second surface S2 of the optical element 302.

After the laser beam L of the laser light source (not illustrated) passes through the third surface S3, the laser beam L is reflected to the first surface S1. The laser beam L enters the first surface S1 at an incident angle θi larger than the total reflection angle θc, such that the laser beam L will be totally reflected. Then, the totally reflected laser beam L passes through the second surface S2. The second surface S2 comprises an anti-reflective layer, such that the laser beam L entering the second surface S2 will not be reflected and instead will completely pass through the second surface S2. Thus, the laser beam L emitted by the light source can be fully utilized.

After the laser beam L passes through the second surface S2, the laser beam L immediately enters the lens module 304, which reflects the laser beam L passing through the second surface S2, such that the reflected laser beam L again passes through the second surface S2, enters the first surface S1 and then is projected on the projection screen 320. Moreover, the lens module 304 may swing in two dimensional directions, such that when the laser beam L reflected by the lens module 304 is projected on the projection screen 320, the projected laser beam L will perform scanning.

FIG. 6 shows a simulation diagram of the beam of the laser projection system 30 of FIG. 5 being projected on a projection screen 320. As indicated FIG. 6, the projection screen 320 has a plurality of description points 3062, and the maximum variation of distortion can be obtained by bringing the values of the description points 3062 in each axial direction to the above LGD equation. Let FIG. 6 be taken for example. In comparison to the maximum variation of distortion (X=4.26%, Y=8.96%) of a conventional scan type projection system, the maximum variation of distortion (X=2.9%, Y=2.2%) of the laser projection system 30 of FIG. 5 is much smaller and has significant improvement. This shows that the optical element 302 (FIG. 5) is capable of improving the distortion and deformation of the projection frame of the conventional scan type projection system.

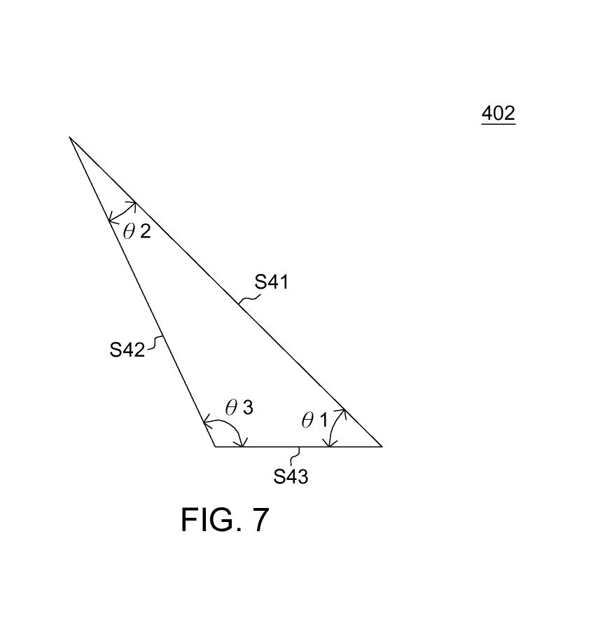

FIG. 7 shows a schematic diagram of an optical element 402 according to an embodiment of the invention. As indicated FIG. 7, the optical element 402 has a first surface S41, a second surface S42 and a third surface S43. The first surface S41 and the third surface S43 form a first angle θ1, the first surface S41 and the second surface S42 form a second angle θ2, and the second surface S42 and the third surface S43 form a third angle θ3. The range of the first angle θ1 is related to the characteristic of the laser beam being totally reflected by the first surface S41. In an embodiment, the first angle θ1 is between 1° to 55°, and the second angle θ2 is between 15° to 45°. In an embodiment, the third surface S43 has two different surfaces: an upper surface (close to the first surface S41) being coated with an anti-reflective material, and a lower surface being a metal reflective surface.

The embodiment of FIG. 7 is exemplified by an optical element 402 having a triangular cross-section. The optical element having other shapes of cross-section can also be used in the laser projection system of the invention as long as the optical element at least has a first surface and a second surface, the first surface totally reflects the incident laser beam, and the totally reflected laser beam further passes through the second surface and enters the lens module for scanning processing would do. The invention does not have particular restrictions regarding the cross-sectional shapes of the optical element.

To summarize, the laser projection system disclosed in the above embodiments of the invention replaces two reflecting mirrors used in a conventional scan type projection system with a special optical element, not only saving element cost but also saving space and benefiting the miniaturization of the laser projection system. In the above embodiments of the invention, the optical element maintains the focus-free characteristic of the laser light source, and improves the distortion and deformation of the projection frame of the conventional scan type projection system.

In an embodiment, by adjusting the inclination angle (tile angle) of a surface of the optical element, the laser beam when emitted by the light source is inclined upwards at an angle, such that the carrying mechanism can be omitted and a preferred projection angle is formed. In an embodiment, the optical element can be directly disposed on an opening in a light emitting area of the casing and used as a dust cover to block the dust, not only reducing element number and cost but also avoiding the stray light affecting the quality of projection image.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A laser projection system, comprising:
a laser light source providing a laser beam;
an optical element having a first surface and a second surface, wherein the laser beam is totally reflected by the first surface to pass through the second surface; and
a lens module disposed adjacent to the second surface of the optical element for reflecting the laser beam passing through the second surface to be projected on a projection screen.

2. The laser projection system according to claim 1, further comprising:
a casing for accommodating the laser light source, the optical element and the lens module, wherein, the casing has an opening and the reflected laser beam passes through the opening to be projected on the projection screen.

3. The laser projection system according to claim 2, wherein the optical element is disposed on the opening and used as a dust cover.

4. The laser projection system according to claim 1, wherein after the laser beam is reflected by the lens module, the reflected laser beam passes through the second surface and is projected on the projection screen via the first surface.

5. The laser projection system according to claim 1, wherein the second surface has an anti-reflective layer.

6. The laser projection system according to claim 1, wherein the lens module is a single lens or a lens assembly, and the single lens or the lens assembly swings in two dimensional directions for reflecting the laser beam passing through the second surface, such that the laser beam is projected on the projection screen by way of scanning.

7. The laser projection system according to claim 1, wherein the optical element further comprises a third surface, and the laser beam passes through the third surface to enter the first surface, the first surface further totally reflects the laser beam to the second surface.

8. The laser projection system according to claim 7, wherein the first surface and the third surface form a first angle, the first surface and the second surface form a second angle, and a range of the first angle is related to a total reflection of the laser beam on the first surface.

9. The laser projection system according to claim 8, wherein the first angle is between 1° to 55°, and the second angle is between 15° to 45°.

10. The laser projection system according to claim 8, wherein the optical element is a prism or a pyramid, and one of the first surface, the second surface and the third surface of the optical element is inclined towards a surface of a casing of the laser projection system.
